(19) United States
(12) Patent Application Publication
(10) Pub. No.: US 2017/0061658 A1
(43) Pub. Date: Mar. 2, 2017

(54) Method for Multi-Parameter Microscopy Visualization

(71) Applicant: Quantitative Imaging Systems, LLC, Monroeville, PA (US)

(72) Inventor: Michel Nederlof, Pittsburgh, PA (US)

(21) Appl. No.: 15/249,156

(22) Filed: Aug. 26, 2016

Related U.S. Application Data
(60) Provisional application No. 62/209,906, filed on Aug. 26, 2015.

(51) Int. Cl. G06T 11/20; G06F 3/16; G06T 15/20; G06K 9/00; G06T 11/00

(52) U.S. Cl. CPC G06T 11/206; G06K 9/00134; G06T 11/001; G06T 15/205; G06F 3/167; G06F 3/04847

(57) ABSTRACT

The present invention discloses a method for visualization of multi-parameter microscopy imaging channels by utilizing a plurality of visualization and audibilization effects. The visualization and audibilization effects include methods for modulating the display of the imaging channels over a period of time. The modulation of the imaging channels may also be driven by data derived from additional imaging channels. The system may also include audibilization effects that assist in the navigation of the microscopy specimens such that the presence of specimen parameters are detected and reported to a user regardless of the current field of view of the specimen navigation viewer. The inventive system also allows for the processing both singly and in combination of image channels for visualization.

### CROSS-REFERENCE TO RELATED APPLICATION

This application claims the benefit of U.S. Provisional Patent Application Ser. No. 62/209,906 entitled “System and Method for Multi-parameter Microscopy Visualization” filed on Aug. 26, 2015, the contents of which are incorporated by reference as if fully set forth herein.

### FIELD OF INVENTION

The present invention relates to the field of microscopy, and more particularly multi-parameter microscopy visualization methods.

### BACKGROUND OF INVENTION

Life science microscopy is a key technology to gain insights into the structure and molecular organization of cells and tissues. Over the last half century, microscopy has gained a large number of imaging modalities and contrast generating methods to improve the distinctness with which molecular features are stained. These methods and modalities may include electron microscopy, florescence microscopy and transmitted light microscopy. Many of these methods can be combined on the same sample to generate multiple independent image channels to visualize and quantitate multiple constituents and processes in the cell. This technique is generally known as multi-parameter microscopy.

The use of multiple fluorescent dyes has been a cornerstone in providing such images since fluorophores can be chosen to fit in specific separable spectral bands. Practical limitations in filter design and throughput have limited this approach to maximally imaging 4 to 6 channels. New technologies are continuing to be developed where this limitation on the number of channels is surpassed and researchers will be able to image many more parameters. Such methods include the repeated removal and re-staining with multiple biomarkers, the use of Quantum Dots, the use of alternative labeling agents such as metals of different mass detected by imaging mass spectroscopy, and creative use of time-resolved fluorescence and structured illumination to gain the ability to use more fluorescence channels. New limits on the number of parameters are currently in the range of 10 to 20, with potential for extremes of up to 60 or more.

Display technology for the visualization of multiple parameter images is currently based on assigning red, green and blue channels for up to only three parameters. The inherent limitation is that if all three channels express an image feature the display will blend to white. Thus, the method works best when image features are sparse and non-overlapping. This becomes increasingly more problematic when trying to visualize more than three channels: additional channels could be assigned magenta, yellow and cyan, but this will quickly wash out to white. More channels also reduce the chances that image features are non-overlapping.

As a result, there is technological gap when it comes to the ability to analyze and visualize the growing number of biomarkers and new instrumentation that are acquiring more of such images concurrently on the same sample. Thus, there is a need for tool to aid in the visualization of this information and to draw conclusions from this wealth of new multi-channel information.

### SUMMARY OF INVENTION

The present invention is designed to provide an extreme multi-parameter visualization method that solves the problem of the ever increasing number of parameters that can be displayed, and addresses the growing need for comparing, quantifying, and correlating multiple biomarkers. We propose a novel method to provide visualizations that are designed specifically for microscopy imaging of many more image channels, segmentation markers and spatial maps of analysis data, than can be sensibly analyzed in the current state of the art. Until the present invention extreme multi-parameter image channels have not been able to be sensibly displayed wherein the viewer of the imaging channels could derive useful information. With the present invention, researchers will now have access to view and perceive data they previously were able to.

The inventive method makes use of multiple visualization audibilizing methods that may be dynamically assigned to imaging channels. These visual and aural effect channels are customizable such that the viewer of the image channel data may optimize the system to perceive information from a multitude of imaging channels. The net effect by using dynamic visual and aural effects is that a viewer of the data may be able to more efficiently perceive data, and will be able to perceive and process a greater amount of imaging channel data than has previously been possible.

### BRIEF DESCRIPTION OF THE DRAWINGS

FIG. 1 is an embodiment of the visualization parameters of the present invention.

FIG. 2 is an embodiment of a multi-parameter visualization system user interface.

FIG. 3 is an embodiment of the multi-parameter visualization system display channel interface.

FIG. 4 is an embodiment of the multi-parameter visualization system visual effects window.

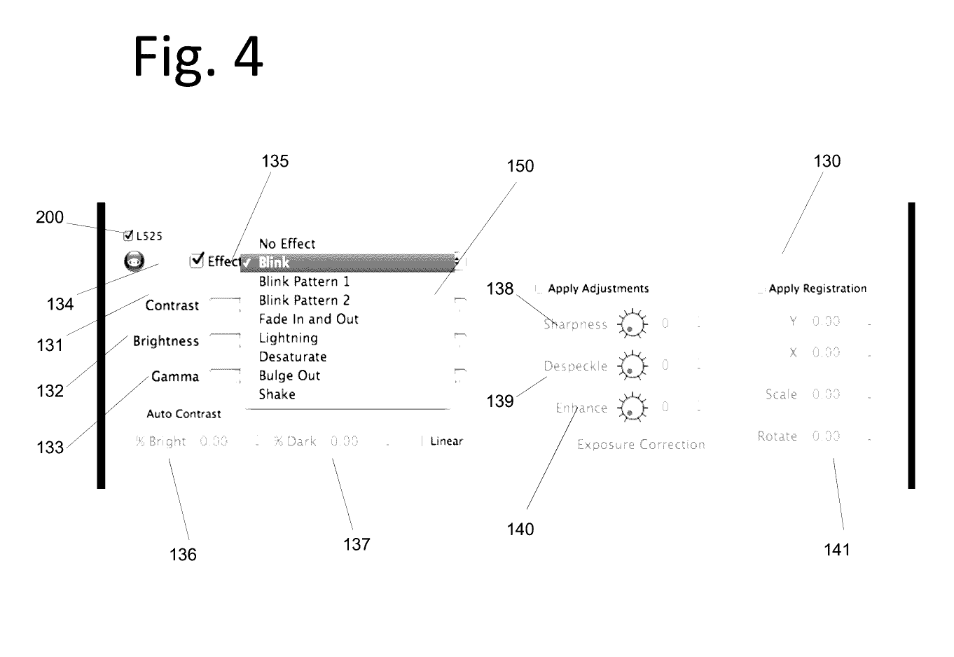

FIG. 5 is an embodiment of a pathway diagram interface.

FIG. 6 is an embodiment of a pathway diagram interface menu.

FIG. 7 is a flow chart of an embodiment of the visualization method of the present invention.

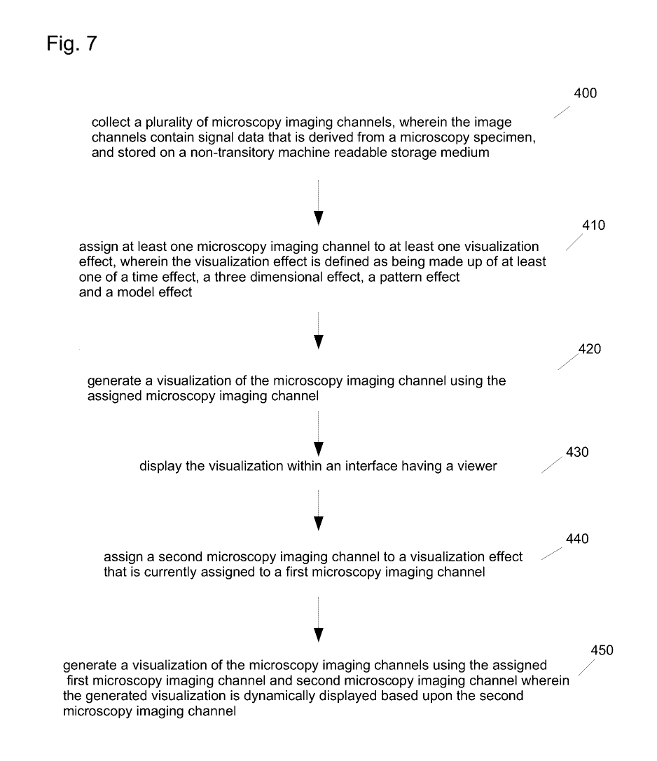

FIG. 8 is a flow chart of the an embodiment of the audibilization method of the present invention.

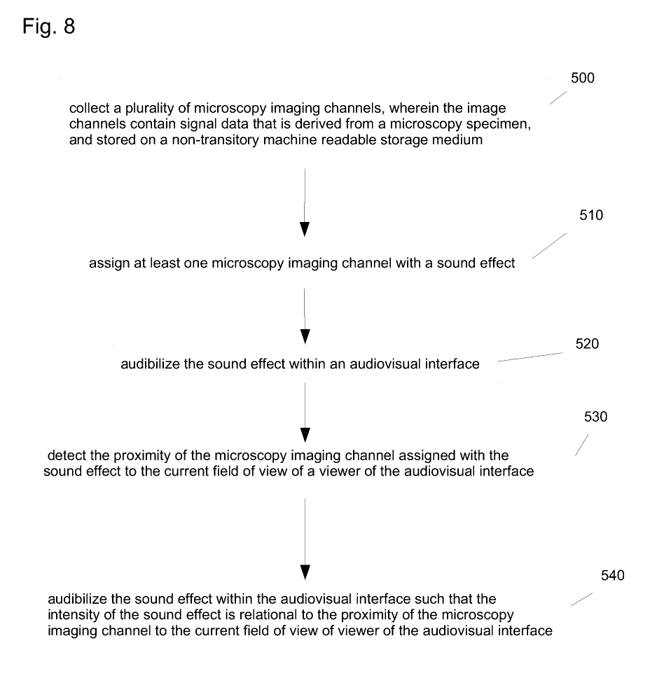

FIG. 9 is a flow chart of an alternative embodiment of the visualization method of the present invention.

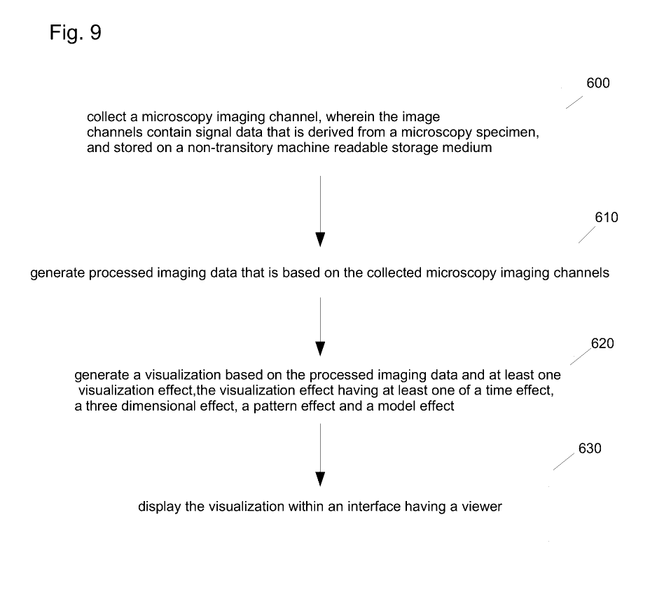

### DETAILED DESCRIPTION OF THE INVENTION

The following detailed description includes the best currently contemplated modes of carrying out exemplary embodiments of the invention. The description is not to be taken in a limiting sense, but is made merely for the purpose of illustrating the general principles of the invention.

The present invention provides a shift from multicolor RGB dimensions to a six-dimensional display paradigm. Traditional display methods use Red, Green and Blue (RGB) channels to render three parameters into a color image. The RGB space is an orthogonal Hilbert space where any color can be rendered. Hardware traditionally provided convenient separate memory buffers for these images. The method is sometimes extended to six colors by assigning Cyan, Yellow and Magenta colors to the additional image channels. These additional channels are less effective since these are not orthogonal axes, but rather linear combinations of the primary RGB channels. Thus displaying more than three channels becomes increasingly difficult when there is spatial overlap between the signals. As a result, the channels wash out into white. Adding more channels will only result in an increase in washing the image out into white, thus this approach is not scalable. Simply stated where their exists more than three overlapping parameters, markers or signals, the image washes out to white and thus provides the researcher limited to no useful data.

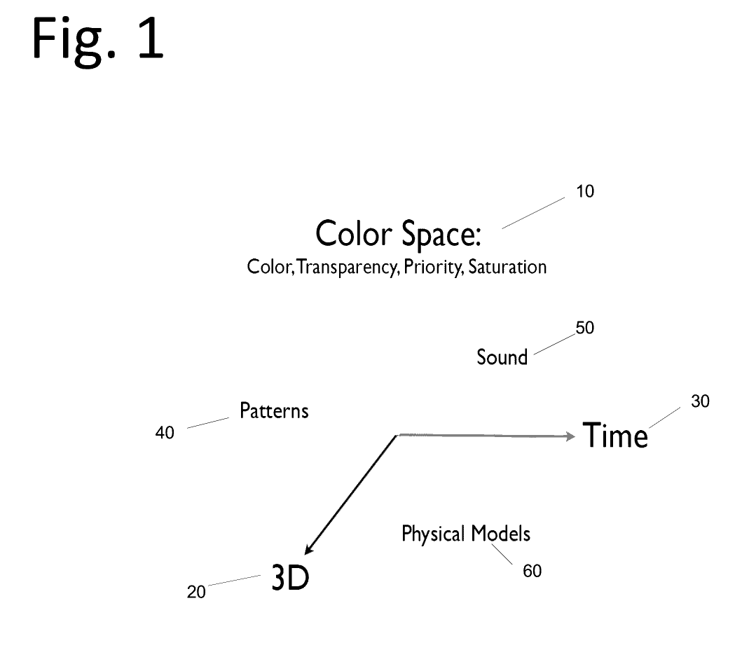

As seen in FIG. 1, present invention's new rendering paradigm is a six dimensional Hilbert space, i.e. six orthogonal rendering parameters. The six independent parameters are Color Space 10 (any variation of the existing RGB or Cyan, Yellow Magenta paradigm), Three-Dimensional 20, Time 30, and Patterns 40, Sounds 50 and Models 60. Each of these new visualization dimensions contain features that logically extent from this disclosure and would be understood by a person of ordinary skill in the art to be disclosed and enabled by this application.

Color Space

In one embodiment, the use of color space 10 is treated as a single dimension, whereas it was formerly a three dimensional space in the prior art. All traditional uses of color to separately render image channels are bundled in one dimension labeled Color Space 10. This includes simply assigning a color hue to each channel, but also assigning a transparency, saturation and intensity. Each channel has an alpha transparency and there is concept of stacking order or priority to the Color Space 10. All currently known color processing techniques are defined as the Color Space 10 in the present invention.

Time Space

The Time Space 30 may make use of time and animations to distinguish more microscopy parameters. In the Time Space 30 the display channels may be animated over time. The simplest animation embodiment is to set a channel to a blink function, where, in one embodiment, the intensity of the display channel is modulated over a period of time. The blink animation may be achieved by using two states in the Color Space 10 for one of the channels and animate between them based upon a given time interval. In one embodiment, the two Color Space 10 states are only different in the value of the intensity (full-on and full-off). In an alternative embodiment, the animated features of the Color Space 10 may be to go from full-saturation to no-saturation. Other periodic modulations are envisioned as well, such as modulating a Color Space 10 feature with a sine wave, square wave, or some preset modulation function. The Time Space 30 animations are not limited to two states but can have many frames of computed (or pre-computed) states of any of the rendering axes.

Three-Dimensional Space

The Three-dimensional Space 20 is another dimension for visualization which contains the use of three-dimensional or 3D effects. In one an embodiment, two-dimensional images can be modeled as deformable “rubber sheets”. While normally appearing flat, the image can be perturbed in several ways to highlight certain image features. Cells of a particular type or selected structures or markers can be identified by letting them “bulge out” periodically, or on a sustained basis. This deformation effect may be done by image processing of the program's software, where the presence of the selected parameter results in a stretching deformation of the image without affecting the Color Space 10 dimension of the image. In this embodiment, the deformation rendering is driven by preset algorithms that are independent of any of the image channels. In alternative embodiments discussed below, image channel data from one or more source may drive modulating features of the visualization, including Three-dimensional Space 20 features.

Pattern Space

Another dimension for visualization is the Pattern Space 40, which is the use of recognizing patterns to distinguish more parameters. Any of the rendering axes of FIG. 1 can be animated to modulate through different states. One never before use microscopy visualization technique relies on the user's ability for pattern recognition. The human brain is particularly adept at pattern recognition, i.e. just as obvious as we can see blue or green, we can hear if a musical rhythm is a waltz or rock and roll. Taking advantage of this pattern recognition ability can easily help distinguish between different channels of information. For example, the blinking modulation may have one channel blink with a fast, short pulse • • • and the other at a slow, long - - - -. In essence, an additional layer of abstract meaning is added to the modulation that may be recognized by the user. By using this additional abstract meaning, additional channels can be differentiated, i.e. additional channels can be sensibly visualized. In alternative embodiment, additional means of distinction may be to have one parameter blink in a pattern and another to be sent to a random blink rate.

Model Space

Another visualizing dimension may be the use of physical models to distinguish more parameters using the Model Space 60. Any of the rendering axes of FIG. 1 can be made to trigger a resemblance to a physical model, i.e. patterns in the rendering of the visualization that are associated with some idea or model. If the model is recognized, the channel is easily separated from other parallel information and an added layer of distinction is made possible. Examples of physical models include a pendulum, lighting strikes, a heartbeat, a crash, shake, etc. Models are similar to patterns but interpreted in a different region of the brain since they require a higher-level logic to process, i.e. the level of abstraction and interpretation to convey meaning is greater than simple rhythmic and tempo patterns.

Sound Space

Yet another visualization technique may be the use of sound to convey more parameters using the Sound Space 50. Use of aural sensory input to covey representative meaning and data is completely absent in the microscopy field, however, the use of sound to convey meaning can be extremely powerful. A leitmotif, use of sound or music to covey a theme or idea is well known in theatrical arts. A good example of a leitmotif is found in movies: the villain is often accompanied by an evil sound; after the audience is trained to associate the two, the director only has to play the sound to invoke a scare and a suspicion that the character is near. Similarly, we can associate sounds, musical phrases or sound patterns with certain cell types, features or specimen objects. In particular, for large images that can extend beyond the field-of-view of a digital microscopy viewer, we can alert the observer that certain structures are near the field of view even though they are not visible yet. This can more reliably draw a user to malignant areas, rare events, or other features of interest and increase the efficiency and accuracy in scanning a whole slide microscopy image.

User Interface

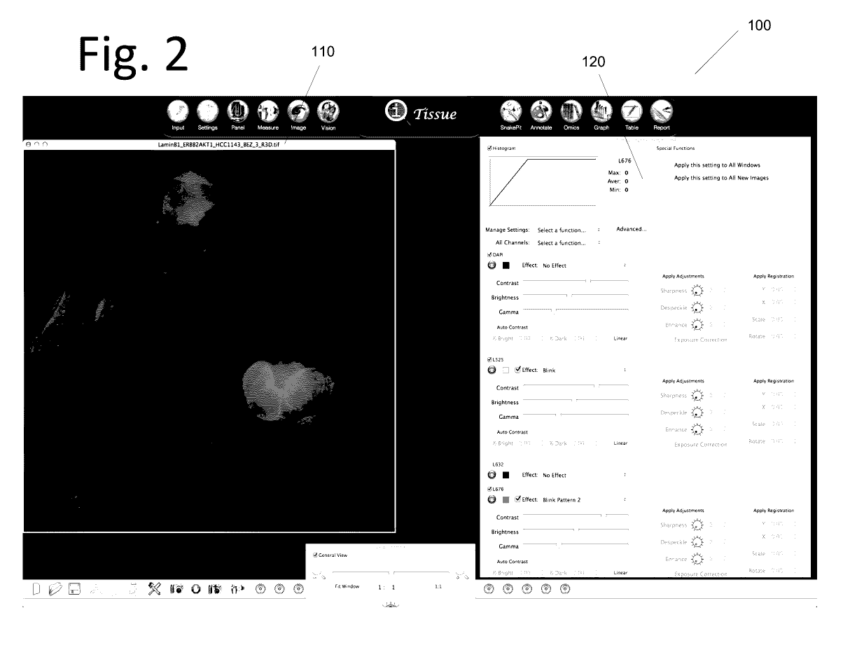

FIG. 2 depicts a user interface 100 of the present invention. In the embodiment depicted of FIG. 2, there is a display window 110 and a channel setting control 120. The channel setting control 120 lists the imaging channels 200 that are being displayed in the display window 110. In FIG. 1 the display window 110 displays cells of various type and the imaging channels 200 being shown are DAPI, L525 and L676. It is understood that any number and classification of channels may be displayed using the interface 100.

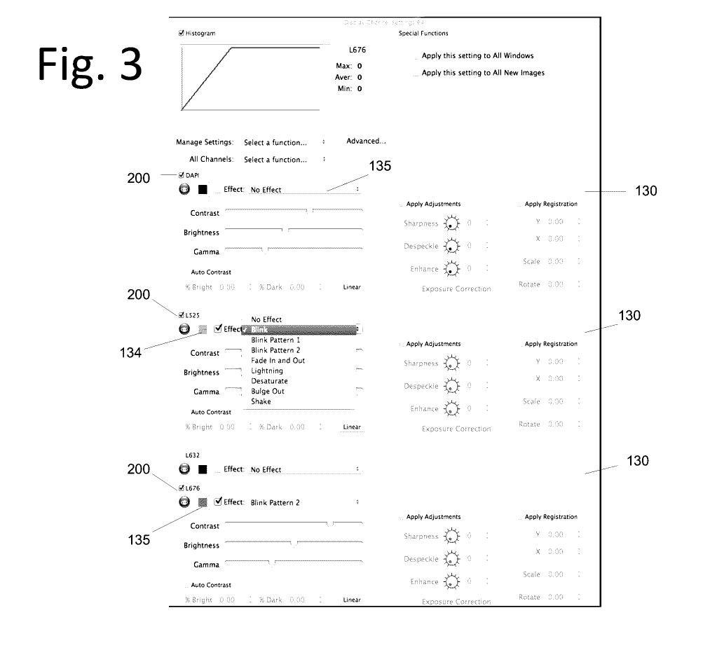

In FIGS. 2 and 3 the channel setting control is depicted. The various settings and features of a channel control box 130 are as follows: adjustment for contrast 131, brightness 132, gamma 133, color 134, visual effects 135, brightness 136 and darkness 137 controls, sharpness 138, despeckle 139 and enhancement 140 controls and positioning 141 controls. FIGS. 2 and 3 displays a list of the some of the possible visual effects that may be used for the increased visualization dimensions in the visual effect-selection menu 150. The listed visualization effects listed in the visual effect-selection menu 150 in this embodiment are blink, blink pattern 1, blink pattern 2, fade in and out, lightning, desaturate, bulge out and shake. When a visual effect is selected from the menu, it will assign that visual effect to the imaging channel, such that the display of the visualization in the display window 110 will relate to the data of the imaging channel.

Additional visualization options and settings may be as follows. Blink: Any channel, or multiple channels can be selected to “blink”, i.e. modulation of the display settings of the image channel. The user can select the blinking pattern and speed, and select physical models 60 such as heartbeat. The user may also modulate the display of the image channel based upon a separate image channel. In this manner, the second image channel dynamically drives the modulation effects on the first image channel without the second image channel otherwise being displayed.

Bulge: a measurement channel is used to create a map of particular cell types. This results in spatial outlines of certain cells. The cells bulge outward three-dimensionally towards the user by applying a deformation matrix on a 3D model of the 2D cell image. The user can select the direction of the effect, pulsating speed, extent and pattern.

Swing: Any channel, or multiple channels can be selected to have an alternative representation in Color Space 10, for example, fully saturated color versus black and white, in front versus in the back, transparent versus opaque, etc. The user can further select the speed, pattern, and physical model by which changes are animated.

Sound: a measurement channel is used to create a map of biomarker expression of an image channel. A sound may be associated with high expression levels of the biomarker. The user can then select sounds, intensity, and patterns to be audibilized when that biomarker imaging channel is detected. While navigating around the visual whole slide image, the sound may adjust to be loudest from the center and drop off with distance, regardless of the current field-of-view. In this way, the method detects the proximity the field-of-view of the display 110 is to the channel source and audiblize the selected sound effect according to the proximity.

In one embodiment multi-parameter channels may be combined to form a single channel for visualization. For example, there may be a grouping of markers that when each are present, indicate some diagnostic significance. In this scenario, rather than provide visualization for each marker independently, the presence of all markers will cause only one visualization technique to be displayed. Similar to this is that an individual or a grouping of markers may indicate some diagnostic significance that the user may want displayed without specifically drawing attention to the presence of the markers themselves. For example, if the existence of certain markers indicates cell death, it may be preferable to create a channel to display a visualization of cell death that does not necessarily highlight the marker indicating cell death. In this manner, the system may process imagining channels to create processed data that may drive a visualization without necessarily displaying the imaging channel itself In this example, the nucleus of the cell may be set to bulge outward due to the presence of markers, wherein if said markers were otherwise displayed on their own, they would wash out the image do to their overlapping of all other channels. Additional examples may include processing the imaging channel into data related to a spatial map of specimen features or the forming the data as a density map. As a result, the present invention allows channels to be customized to display a plurality of markers, and to display an alternatively processed imaging data in response to a imaging channel without displaying the imaging channel itself. It further understood that other customized channel configuration may also be implemented by the present invention.

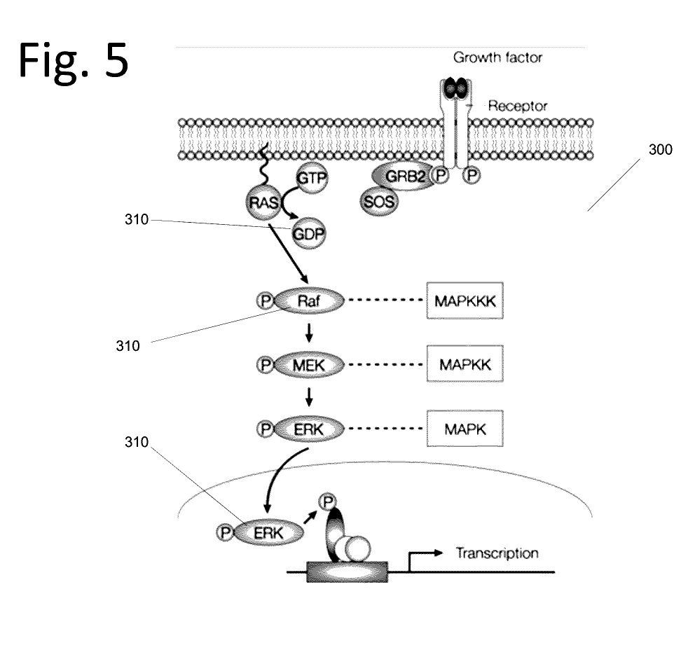

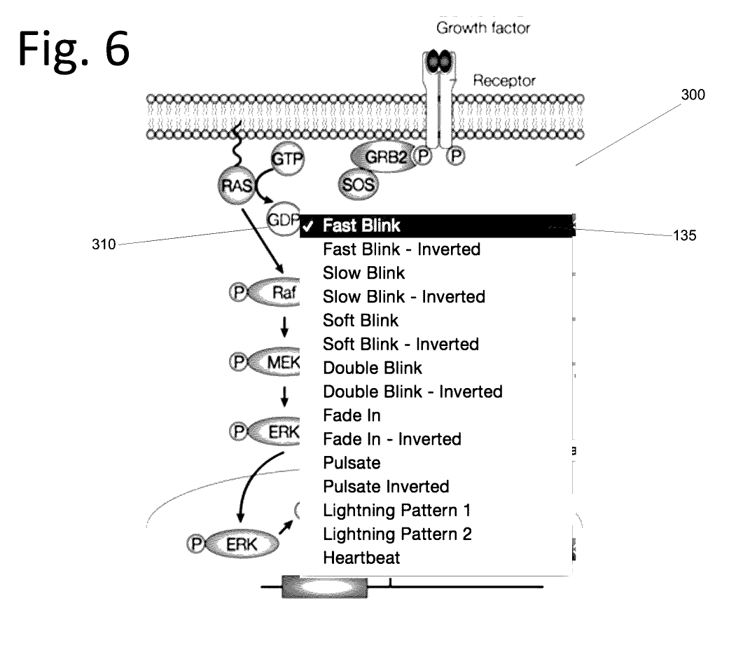

In one embodiment, the user interface may contain a logical pathway diagram 300 depicting the constituents 310 of the microscopy sample as depicted in FIG. 5 and FIG. 6. The logical pathway diagram 300 is known in the art to represent the chemical/marker interaction of a given biological system. The logical pathway diagram 300 in FIGS. 5 and 6 may be configured to allow the user to click on the individual constituents marker representation 310 to open up the visualization control panel 135 for the selected marker. FIG. 6 depicts a visualization control panel 135 for a selected marker 310 from the pathway diagram 300. The utility of the pathway diagram GUI 300 is that the user may be able to quickly select and change the visualization settings for various imaging channels without having to go through multiple menus to find the imaging channel they wish to edit.

It is further contemplated that other graphical representation of biological systems may be used as the GUI for the visualization settings. For example, the image used could be of whole tissues at slightly lower magnification. In this model the tissue architecture and functionality, such as ductal structure, vascular systems, stroma and tumors could be the interface structures of the GUI. Persons having ordinary skill in the art will understand that there are many available biological systems that can be used as a GUI for the present invention so to customize the GUI for the particular samples being examined.

The interface 100 is operates on any standard computer system having a processor and non-transitory data storage device. The visualization of the microscopy imaging channels may be performed from the following steps. First the visualization program will collect a plurality of microscopy imaging channels, wherein the image channels contain signal data that is derived from a microscopy specimen, and stored on a non-transitory machine readable storage medium 400. Next the program will assign at least one microscopy imaging channel to at least one visualization effect, wherein the visualization effect is defined as being made up of at least one of a time effect, a three dimensional effect, a pattern effect and a model effect 410. The system then generates a visualization of the microscopy imaging channel using the assigned microscopy imaging channel 420. Finally the system displays the visualization within an interface having a viewer 430.

In an alternative embodiment where an imaging channel drives a visualization effect the system may assign a second microscopy imaging channel to a visualization effect that is currently assigned to a first microscopy imaging channel 440. The system will then generate a visualization of the microscopy imaging channels using the assigned first microscopy imaging channel and second microscopy imaging channel wherein the generated visualization is dynamically displayed based upon the second microscopy imaging channel 450. Here, the visualization displayed the first imaging channel and the visualization of first imaging channel is modulated by the second imaging channel.

In an alternative embodiment, the system utilizes sound to audiblize the imaging channel. In that method the system collects a plurality of microscopy imaging channels, wherein the image channels contain signal data that is derived from a microscopy specimen, and stored on a non-transitory machine readable storage medium 500. The system then assigns at least one microscopy imaging channel with a sound effect 510 and proceeds to audibilize the sound effect within an audiovisual interface 520. One manner in which the system may audiblize the sound effect may be where the system detects the proximity of the microscopy imaging channel assigned with the sound effect to the current field of view of a viewer of the audiovisual interface 530. The system then will audibilize the sound effect within the audiovisual interface such that the intensity of the sound effect is relational to the proximity of the microscopy imaging channel to the current field of view of viewer of the audiovisual interface 540.

In yet another embodiment, the system may create visualizations based off of an imaging channel without directly displaying the image within the imaging channel. In that method the system collects a microscopy imaging channel, wherein the image channel contain signal data that is derived from a microscopy specimen, and stored on a non-transitory machine readable storage medium 600. The system will then generate processed imaging data that is based on the collected microscopy imaging channels 610 and then generate a visualization based on the processed imaging data and at least one visualization effect, the visualization effect having at least one of a time effect, a three dimensional effect, a pattern effect and a model effect 620. Finally the system will display the visualization within an interface having a viewer 630. Persons having skill in the art will understand that the processed imaging data may be derived from a single imaging channel or it may come from a combination of imaging channels which may be determined by the biological usefulness of the singly or combined channel data.

It is contemplated that the preceding system of visualization may be implemented beyond just the field of multi-parameter microscopy, but may include other fields where enhanced visualization may provide benefits. For example, use within the fields of radiology and with MRI images may be performed by creating new channels, beyond black and white images, that can be displayed using the enhanced visualization techniques of the present invention. In one example, identified calcification in an image may be selected as a dedicated channel where it could then be selected to appear to blink, bulge, etc. As a result, objects of interest in various fields may be highlighted using the visualization techniques of the present invention.

One additional feature of the user interface may be that it will be designed to avoid limits of colorblind users. The RGB model only offers three independent axes, but this is even worse for users that are Red/Green colorblind (8% of men). Taking advantage of the five other sensory inputs can completely bypass this limitation, thereby providing allowing colorblind users to visualize without the impairment of ordinary visualization techniques.

It is understood there are many numerous visualization effects that may also be added to this list and it is further intended that the user may add, edit, and create his or her own visual effects to further provide visual differentiation of the displayed parameters. In one embodiment, the user interface may have interactive display inputs. As a result, the image and data display will not be a static affair. Much more can be gained if the user can interact with the information and has options to “play” with what is presented.

It should be understood, of course, that the foregoing relates to exemplary embodiments of the invention and that modifications may be made without departing from the spirit and scope of the invention as set forth in the following claims.

I claim:

1. A method for displaying microscopy imaging channels using a plurality of visualizations comprising the steps of:
a) collecting a plurality of microscopy imaging channels, wherein the image channels contain signal data that is derived from a microscopy specimen, and stored on a non-transitory machine readable storage medium;
b) assigning at least one microscopy imaging channel to at least one visualization effect, the visualization effect having at least one of a time effect, a three dimensional effect, a pattern effect and a model effect;
c) generating a visualization of the microscopy imaging channel using the assigned microscopy imaging channel;
d) displaying the visualization within an interface having a viewer.

2. The method for displaying microscopy imaging channels using a plurality of visualizations of claim 1 further comprising:
e) assigning a second microscopy imaging channel to a visualization effect that is currently assigned to a first microscopy imaging channel;
f) generating a visualization of the microscopy imaging channels using the assigned first microscopy imaging channel and second microscopy imaging channel wherein the generated visualization is dynamically displayed based upon the second microscopy imaging channel.

3. The method for displaying microscopy imaging channels using a plurality of visualizations of claim 1 further comprising the visualization effect having a color effect.

4. The method for displaying microscopy imaging channels using a plurality of visualizations of claim 1 wherein the time effect modulates a parameter of the visualization in a predetermined pattern over time.

5. The method for displaying microscopy imaging channels using a plurality of visualizations of claim 1 wherein the three dimensional effect modulates a three-dimensional rendering effect of the visualization in a predetermined pattern over time.

6. The method for displaying microscopy imaging channels using a plurality of visualizations of claim 1 further comprising selecting the visualization to be assigned to the microscopy imaging channel using the interface, wherein the interface has a visualization-channel selection menu.

7. The method for displaying microscopy imaging channels using a plurality of visualizations of claim 6, wherein the visualization-channel selection menu is a logical diagram depicting the constituents of the microscopy sample, where the selection of the constituents of the logical diagram controls the visualization.

8. The method for displaying microscopy imaging channels using a plurality of visualizations of claim 6, further comprising selecting visualization transitions settings from the visualization-channel section menu that control the visualization over a period of time.

9. The method for displaying microscopy imaging channels using a plurality of visualizations of claim 1, wherein the visualization is generated using hardware emulation.

10. The method for displaying microscopy imaging channels using a plurality of visualizations of claim 1, wherein the visualization is generated using software emulation.

11. A method for displaying microscopy imaging channels using a sound effect comprising the steps of:
a) collecting a plurality of microscopy imaging channels, wherein the image channels contain signal data that is derived from a microscopy specimen, and stored on a non-transitory machine readable storage medium;
b) assigning at least one microscopy imaging channel with a sound effect;
c) audibilizing the sound effect within an audiovisual interface.

12. The method for displaying microscopy imaging channels using a sound effect of claim 11, further comprising the steps of:
d) detecting the presence of the microscopy imaging channel assigned with the sound effect within a viewer of the audiovisual interface;
e) audibilizing the sound effect within the audiovisual interface when the presence of the microscopy imaging channels assigned with the sound effect is detected within the viewer of the audiovisual interface.

13. The method for displaying microscopy imaging channels using a sound effect of claim 11, further comprising the steps of:
d) detecting the proximity of the microscopy imaging channel assigned with the sound effect to the current field of view of a viewer of the audiovisual interface;
e) audibilizing the sound effect within the audiovisual interface such that the intensity of the sound effect is relational to the proximity of the microscopy imaging channel to the current field of view of viewer of the audiovisual interface.

14. The method for displaying microscopy imaging channels using a sound effect of claim 11, further comprising the steps of:
d) assigning at least one microscopy imaging channel to at least one visualization effect, the visualization effect having at least one of a time effect, a three dimensional effect, a pattern effect and a model effect;
e) generating a visualization of the microscopy imaging channel using the assigned microscopy imaging channel;
f) displaying the visualization within an interface having a viewer.

15. The method for displaying microscopy imaging channels using a sound effect of claim 14, further comprising the steps of:
e) assigning a second microscopy imaging channel to a visualization effect that is currently assigned to a first microscopy imaging channel;
f) generating a visualization of the microscopy imaging channels using the assigned first microscopy imaging channel and second microscopy imaging channel wherein the generated visualization is dynamically displayed based upon the second microscopy imaging channel.

16. The method for displaying microscopy imaging channels using a sound effect of claim 11, further comprising the steps of: selecting the assignment for the microscopy imaging channels using the interface, wherein the interface has a channel-selection menu.

17. A method for displaying microscopy imaging channels using a plurality of visualizations comprising the steps of:
a) collecting a microscopy imaging channel, wherein the image channel contain signal data that is derived from a microscopy specimen, and stored on a non-transitory machine readable storage medium;
b) generating processed imaging data that is based on the collected microscopy imaging channels;
c) generating a visualization based on the processed imaging data and at least one visualization effect, the visualization effect having at least one of a time effect, a three dimensional effect, a pattern effect and a model effect;
d) displaying the visualization within an interface having a viewer.

18. The method for displaying microscopy imaging channels using a plurality of visualizations of claim 17, further comprising generating a processed imaging channel that is based on a plurality of collected microscopy imaging channels and displaying a visualization based upon the processed imaging channel within an interface having a viewer.

19. The method for displaying microscopy imaging channels using a plurality of visualizations of claim 17, wherein the processed image data relates to a spatial map of specimen features.

20. The method for displaying microscopy imaging channels using a plurality of visualizations of claim 17, wherein the processed image data forms a density map.
